(19) United States
(12) Patent Application Publication
(10) Pub. No.: US 2004/0200315 A1
(43) Pub. Date: Oct. 14, 2004

(54) Cam timer adjuster

(76) Inventors: Edward T. Bourne, Walnut, CA (US); Sherman A. Durousseau, Walnut, CA (US)

Correspondence Address: James E. Brunton, Esquire, Suite 860, 700 N. Brand Blvd., Post Office Box 29000, Glendale, CA, 91203, US

(21) Appl. No.: 10/408,618

(22) Filed: Apr. 11, 2003

(51) Int. Cl. F16H 35/06

(52) U.S. Cl. 74/640

(57) ABSTRACT

An adjustable timing gear assembly and the method of making same that can readily be adjusted in the field in a manner to permit precise cam timing adjustments without having to remove the engine timing belt from the gear member of the apparatus. Importantly, the gear assembly includes strategically located and configured mating serrations that function to positively prevent accidental relative rotation between the gear member and the hub member of the device which is connected to the engine camshaft

### BACKGROUND OF THE INVENTION

1. Field of the Invention

The present invention relates generally to valve timing for internal combustion engines. More particularly, the present invention concerns an adjustable timing gear for accomplishing precise camshaft adjustments.

2. Discussion of the Prior Art

Most internal combustion engines use intake valves to control the entry of combustible gases into the combustion chamber of the engine for ignition by a spark generated by a spark plug. Following combustion of the combustible gases within the combustion chamber, exhaust valves are used to control the escape of exhaust gases resulting from the combustion. Typically, both the intake and exhaust valves are controlled by cam lobes provided on the engine camshaft. Pistons reciprocally movable within the combustion chamber are driven by the combustion of the combustible gases to cause the rotation of a crankshaft. The crankshaft functions to translate the up-and-down motion of the piston into a rotating force that is used to impart rotation to the wheels of the vehicle.

It is well understood that the timing of the opening and closing of intake and exhaust valves is critical to optimum operation of the engine. Typically, in conventional prior art internal combustion engines, the cam shaft is driven by a gear connected to the crankshaft. Power is transmitted to the cam shaft either through a drive chain, a positive drive cog belt or another gear and, as a general rule, it is not possible to expeditiously change the rotational phase of the cam shaft with respect to the crank shaft. Accordingly, there has been a demand to develop ways by which the rotational phase of the camshaft with respect to the crankshaft can be more easily adjusted. Being able to readily accomplish these adjustments not only permits an improvement in engine performance, but also provides a means by which fuel consumption can be reduced. Additionally, it has been determined that the quantity of nitrogen oxides in the exhaust gases can be reduced by changing the rotational phase of a camshaft relative to the crankshaft.

In many prior art automobiles a sprocket and chain system is used to interconnect the camshaft with the crankshaft. The combination of camshaft sprocket, the timing chain and the crankshaft sprocket controls the rotation of the camshaft relative to the crankshaft. Adjustment of the rotation of the camshaft relative to the crankshaft in increments of even one or two degrees can markedly effect engine performance. For this reason, timing is usually a design characteristic of the engine that is determined and fixed by the engine manufacturer. More specifically, timing is usually fixed by cooperating keys and keyways provided on the crankshaft and the crank sprocket and on the camshaft and cam sprocket.

Experience has shown that, while the engine timing preset by the manufacturer is generally sufficient for a wide range of engine uses, it may not be optimum for particular purposes, such as racing, off-roading, towing and the like. For example, it is well understood that advancing the camshaft by adjusting the camshaft position relative to the crankshaft increases the lower rotations per minute (RPM) power, while retarding the camshaft by adjusting the camshaft position relative to the crankshaft improves the higher RPM power.

In the past, a number of different types of “after market” timing sets have been designed and made commercially available to replace the original equipment timing set on certain types of commercial vehicles. These “after market” timing sets permit some adjustment to the preset manufacturers timing specification. One such after market timing set is offered for sale by Advanced Engine Management, Inc. of Hawthorne, Calif. This device, referred to by the manufacturer as “an adjustable timing gear”, comprises an outer member having a toothed peripheral portion and a mounting web that spans the peripheral portion. Connected to the mounting web by three circumferentially spaced connector bolts is a hub member that is adapted to be interconnected with the camshaft. The hub member is provided with a plurality of circumferentially, spaced-apart, elongated openings through which the connector bolts extend. By loosening the connector bolts, the hub member can be rotated relative to the outer member to the extent permitted by the elongated openings provided in the hub member. For example, certain of the adjustable cam gears manufactured by Advanced Engine Management can be advanced or retarded up to 10 degrees each way in one-degree increments.

U.S. Pat. No. 4,096,836 issued to Kopich discloses a variable timing device for engine camshafts. The Kopich invention provides an arrangement for securing timing drive components such as sprockets and camshafts in which portions of the securing and adjusting devices are combined so that the number of components required and the openings which must be provided are both reduced and the strength of the associated parts is thereby purportedly increased.

The patent to Gossett U.S. Pat. No. 1,578,983 concerns a loom gear. More particularly, the Gossett invention discloses a loom drive gear having a hub member adapted to be keyed to the shaft of the loom. The hub member has a radial flange provided with circumferentially spaced arcuate slots and with a series of radial serrations on its innerface. The Gossett device also includes a gear member consisting of a toothed gear rim and a central disc having a central hole for fitting over the hub member. The central disc is provided with a series of radial serrations that are adapted to engage the serrations on the hub flange when the components are clamped together by a series of clamping bolts. The announced objective of the Gossett invention is to provide simple means for accommodating for wear on the gear teeth. This is accomplished by loosening the connector bolts and then rotatably adjusting gear rim relative to the hub as wear occurs on the gear teeth.

U.S. Pat. No. 3,789,687 issued to Cutter concerns a sprocket assembly having a two-piece hub supporting a sprocket wheel on a shaft. One part of a hub is circumferentially spaced from the other and both hub parts are interconnected by a pair of threaded studs each of which is pivotally supported at one end and carries a nut at the other hand for adjusting the angular position of the sprocket wheel relative to the shaft.

### SUMMARY OF THE INVENTION

By way of summary, the adjustable timing gear assembly of the present invention comprises a gear member having a peripheral portion, a multiplicity of drive belt engaging, spaced apart teeth formed on the peripheral portion and an inner mounting web connected to and spanning the peripheral portion. The peripheral portion and the inner-mounting web cooperate to define a generally cylindrically shaped internal chamber which telescopically receives the hub member of the timing gear assembly. The inner mounting web of the gear member has an inner surface, an outer surface, a central opening. A plurality of circumferentially spaced apart threaded bores, which are formed in the inner mounting web are constructed and arranged to threadably receive the connector bolts of the assembly which function to releasably interconnect the gear member with the hub member. In one form of the invention the inner surface of the web member is also provided with 180 tooth-like, radially extending, strategically formed serrations that are spaced apart by two degrees.

The hub member of the adjustable timing gear assembly has a peripheral portion, a central opening and a plurality of circumferentially spaced-apart, elongated openings adapted to receive the connector bolts of the device. The hub member also has an inner surface that is provided with 180 tooth-like, radially extending serrations that are adapted to closely mesh with the radially extending serrations formed on the gear member when the components are interconnected by the connector bolts. The strategically formed serrations function to positively prevent accidental relative rotation between the gear member and the hub member during engine operation. However, by loosening the connector bolts by approximately 1½ turns, the mating serrations can be moved out of engagement, thereby permitting controlled, relative rotation between the gear member and the hub member to enable precise timing adjustments in two degree increments.

In an alternate form of the invention, the gear member and the hub member are provided with 360 mating serrations that permit precise timing adjustments in one degree increments.

It is an object of the present invention to provide a readily adjustable timing gear of the character described in the preceding paragraphs that includes means for permitting precise cam timing adjustments in the field without having to remove the engine timing belt from the gear member of the apparatus.

Another object of the invention is to provide an adjustable timing gear of the aforementioned character which includes strategically located and configured means for positively preventing accidental relative rotation between the gear member and the hub member of the device which is connected to the engine camshaft.

Another object of the invention is to provide an adjustable timing gear that is easy to use and one that can be easily connected to a conventional engine camshaft without the need for special tools.

Another object of the invention is to provide an adjustable timing gear of the character described in the preceding paragraphs that enables precise timing adjustments in either one or two degree increments.

Another object of the invention is to provide a method of making an adjustable timing gear of the type described in the preceding paragraphs which insures that the serrations formed on the gear member and on the hub member closely and precisely mesh when the components are operably interconnected together.

Another object of the invention is to provide an adjustable timing gear of the class described that is of a simple design and one that can be inexpensively manufactured in quantity in accordance with the method of the invention.

### BRIEF DESCRIPTION OF THE DRAWINGS

FIG. 1 is a generally perspective view of one form of the adjustable timing gear of the invention.

FIG. 2 is a generally perspective, exploded view of the adjustable timing gear shown in FIG. 1.

FIG. 3 is an enlarged, cross-sectional view taken along lines 3-3 of FIG. 1.

FIG. 4 is a fragmentary cross-sectional view taken along lines 4-4 of FIG. 3.

FIG. 5 is a rear view of the gear member of the invention showing the serrated inner surface thereof.

FIG. 6 is a front view of the gear member of the invention showing the outer surface thereof.

FIG. 7 is a cross-sectional view taken along lines 7-7 of FIG. 5.

FIG. 8 is a front view of the hub member of one form of the adjustable timing gear of the invention showing the serrated inner surface thereof.

FIG. 9 is a rear view of the hub member of one form of the adjustable timing gear of the invention.

FIG. 10 is a cross-sectional view taken along lines 10-10 of FIG. 8.

FIG. 11 is a greatly enlarged, fragmentary view of the adjustable timing gear of the invention showing more clearly the serrated inner surface thereof.

FIG. 12 is a greatly enlarged, fragmentary view of the serrated inner surface of the hub member of the invention.

FIG. 13 is a greatly enlarged fragmentary view of an alternate form of the adjustable timing gear of the present invention showing the differently configured serrated inner surface thereof.

FIG. 14 is a greatly enlarged fragmentary view of the serrated inner surface of the hub member of the alternate form of the invention shown in FIG. 13.

### DESCRIPTION OF THE INVENTION

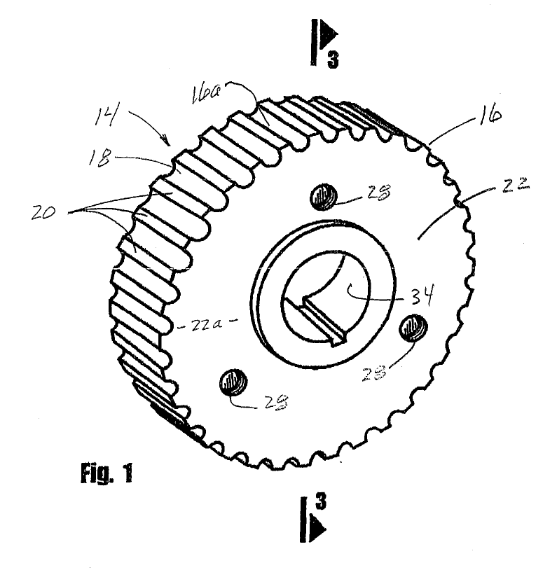

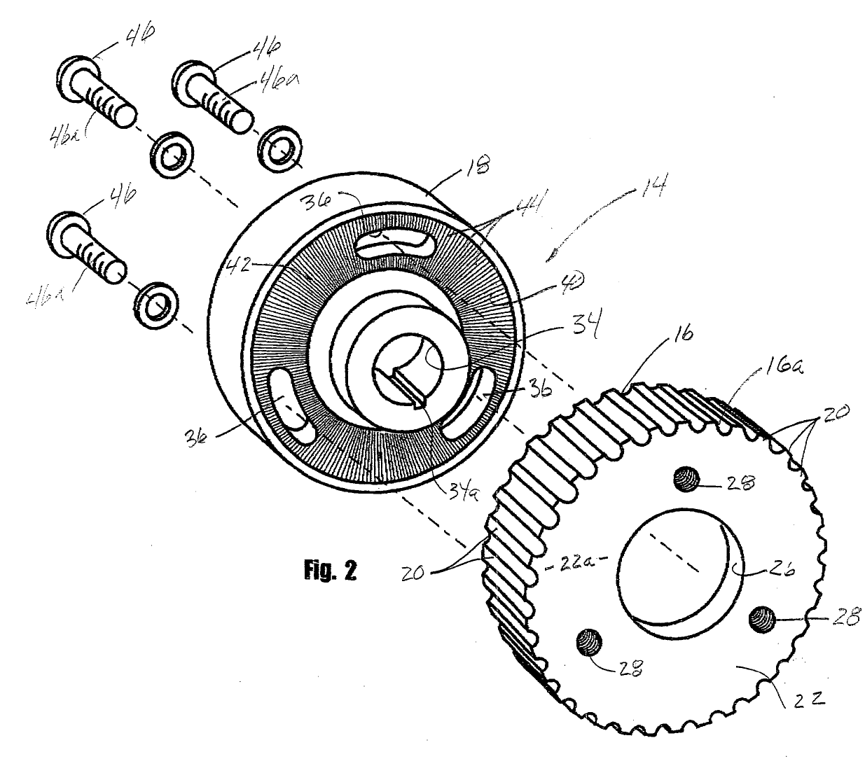

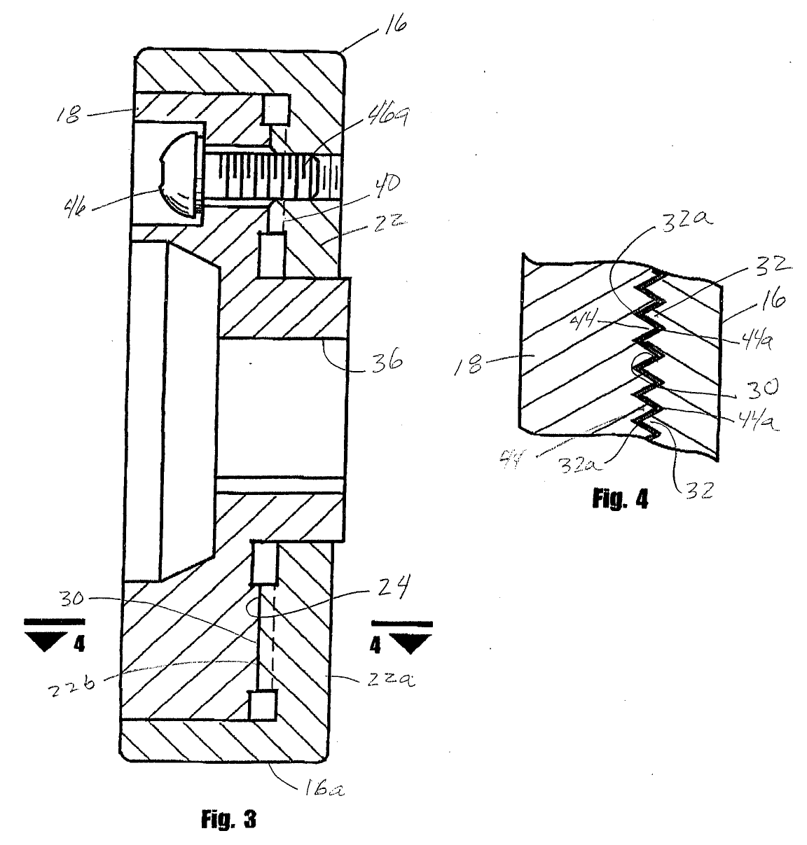

Referring to the drawings and particularly to FIGS. 1 through 5, one form of the adjustable timing gear of the invention is there shown in generally designated by the numeral 14. As best seen by referring to FIG. 2, the adjustable timing gear 14 here comprises a gear member 16, a hub member 18 and connector means for interconnecting the hub member with the gear member. As shown in FIGS. 1 and 2, gear member 16 has a peripheral portion 16a having a multiplicity of spaced-apart timing belt engaging teeth 20 formed thereon and an innermounting web 22 connected to peripheral portion 16a and extending inwardly therefrom. The peripheral portion and the inner mounting web cooperate to define a generally cylindrically shaped internal chamber 24 (FIG. 3), which, in a matter presently to be described, telescopically receives the hub member 18 of the adjustable timing gear assembly.

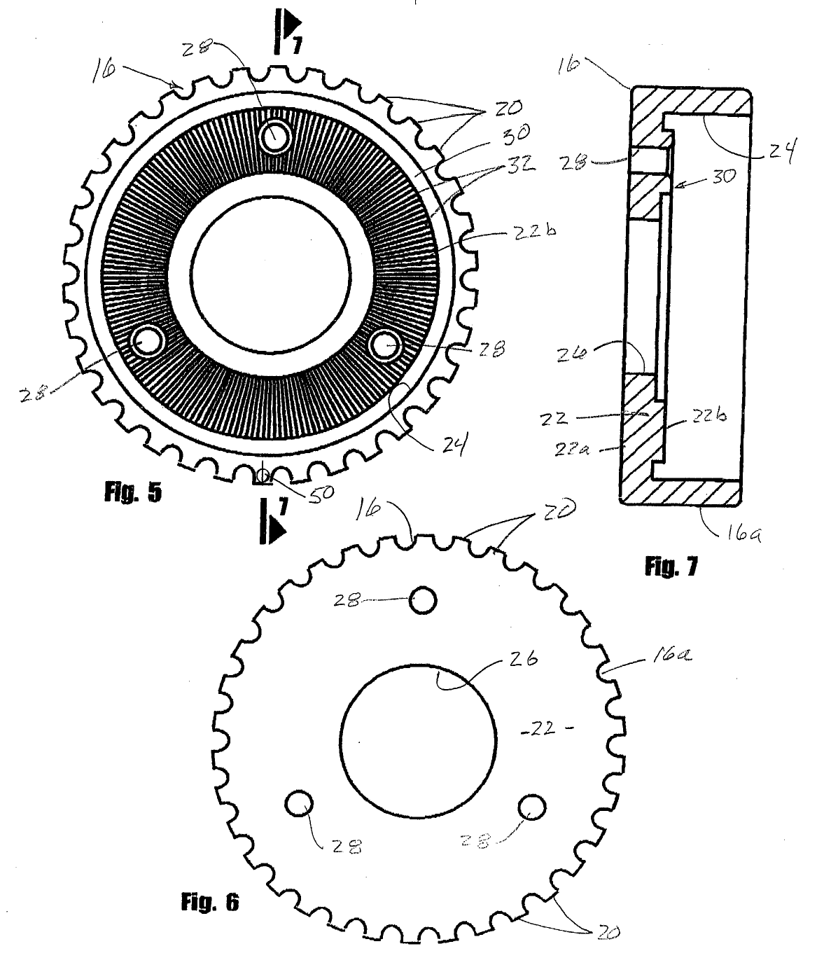

Inner mounting web 22 has an outer surface 22a, an inner surface 22b (FIG. 7), a central opening 26 and a plurality of circumferentially spaced apart threaded bores 28. As best seen in FIG. 5, inner surface 22b has an annular shaped portion 30 that extends from central opening 26 to peripheral portion 16a. Strategically formed on annular portion 30 are a multiplicity of spaced apart, tooth like serrations 32 which extend radially inwardly along a substantial portion thereof. As best seen in FIG. 4, serrations 32 are tooth like in configuration, with each serration being generally triangularly shaped in cross-section and having a relatively sharp apex 32a.

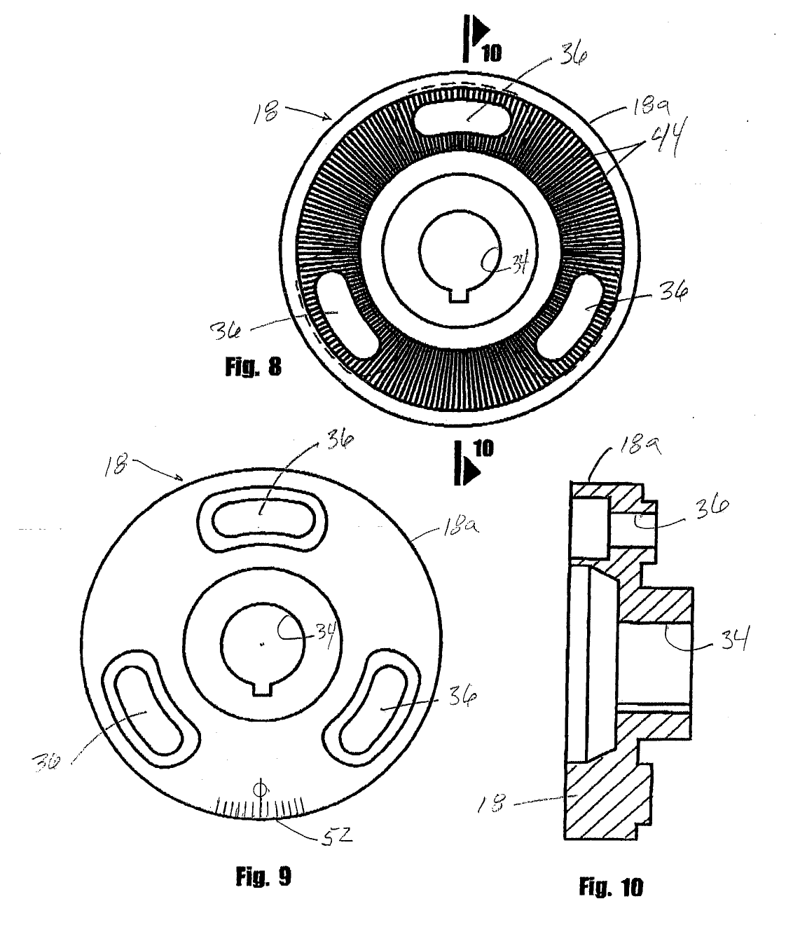

As illustrated in FIGS. 2, 8, 9 and 10, hub member 18, which can be readily connected to the engine camshaft in a conventional manner, also has a peripheral portion 18a, a central opening 34 having a keyway 34a and a plurality of circumferentially spaced-apart, elongated openings 36. Hub member 18 also has an outer surface 38 and an inner surface 40. As shown in FIG. 2, inner surface 40 includes an annular shaped portion 42 that extends between central opening 34 and peripheral portion 18a. As shown in FIGS. 2 and 8, annular portion 42 is provided with a multiplicity of spaced-apart serrations 44 which extend radially inwardly along a substantial portion of the annular portion of in the inner surface of the hub member. Serrations 44, like serrations 32, are tooth like in configuration, with each serration being generally triangularly shaped in cross-section and having a relatively sharp apex 44a (FIG. 4).

Connector means, shown here as a plurality of bolts 46 having threaded shanks 46a, are operably associated with gear member 16 and function to interconnect hub member 18 with the gear member 16 in the manner shown in the drawings. As illustrated in FIG. 3, the threaded shank portions 46a of the bolts 46 are threadably receivable within the circumferentially spaced apart threaded bores 28 formed and mounting web 22. As previously mentioned and as depicted in FIG. 4, serrations 44 are strategically formed and are constructed and arranged so as to closely mesh with serrations 32 formed on mounting web 22 when the components are operably interconnected.

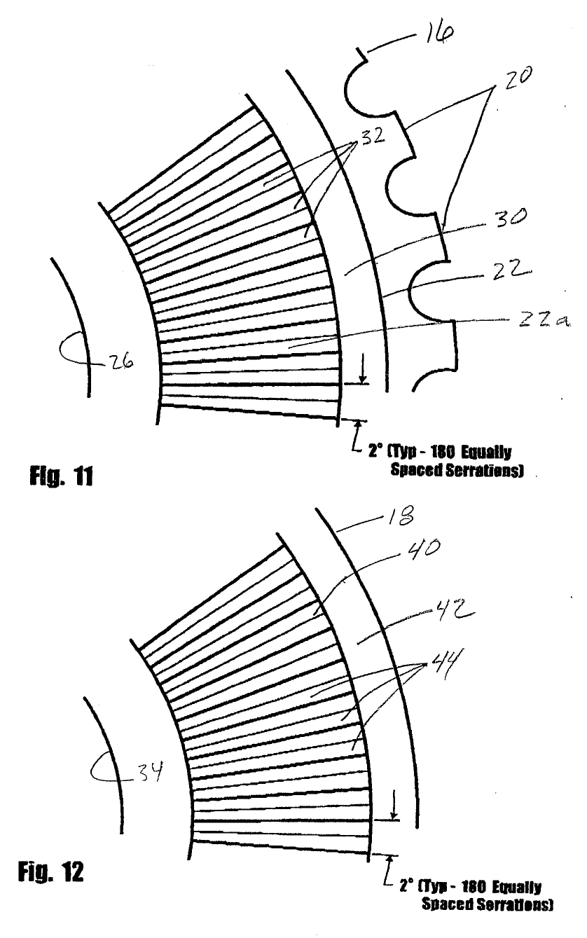

In the embodiment of the invention shown in FIGS. 1 through 12, one hundred and eighty mating serrations, which are spaced approximately two degrees apart, are formed on both the gear member 16 and the hub member 18.

To ensure that serrations 32 closely mesh with serrations 44, the serrations on both the mounting web 22 and on the hub member 18 are uniquely formed in accordance with one form of the method of the invention. In forming the serrations on the mounting web 22, the first step in the method of the invention is to turn the inner face 22b of the mounting web at 1 degree negative. This step creates a slightly inwardly angled (by one degree) inner surface 22b. The next step in the method is to mill the serrations, or teeth 32 at 1 degree positive. In milling these serrations it is, of course, apparent that the cut made by the 60-degree milling tool used to cut the serrations is deeper toward the periphery of the web member and more shallow toward the central opening 26.

Forming the teeth 44 on the hub member is done by a similar process. More particularly, the inner face 40 of the hub member 18 is first turned at 1 degree negative. This step creates a slightly inwardly angled (by one degree) inner surface 40. The next step in the method comprises milling the serrations, or teeth 44 at 1 degree positive. In milling serrations 44, it is once again apparent that the cut made by the 60-degree milling used to cut the serrations is deeper toward the periphery of face 40 and more shallow toward the central opening 36.

When the hub member 18 is mated with the gear member 16 in a manner best seen in FIG. 3, the serrations or teeth 32 and 44 formed in accordance with the method described in the preceding paragraph will closely mesh in the manner more clearly illustrated in FIG. 4 of the drawings.

Unlike competitive adjustable cam gears, so long as the serrations on the gear member and on the hub member of the apparatus of the present invention are maintained in the close meshing relationship depicted in FIG. 4 by the tightened connector members or bolts 46, relative rotation between the gear member and the hub member will be positively prevented even under conditions of severe vibration. When it is desired to adjust the camshaft timing, bolts 46 can be loosened about 1½ turns to provide clearance of between about 0.0500 in 0.0800 inches clearance between the inner faces of the hub member and the gear member. This clearance is sufficient to permit the serrations or teeth to move out of their meshing relationship. When this is accomplished, hub member 18, along with the engine camshaft, can be rotated relative to gear member 16 in fixed increments to accomplish highly precise timing adjustments. During this adjustment, the threaded shank portions of the loosened bolts 46 will move freely within elongated openings 36 provided in the hub member. Because of the minimum axial movement required between the gear member and the hub member during the adjustment step, removal of the timing belt is not necessary to accomplish the timing adjustments. As illustrated in FIGS. 5 and 9, calibrated markings 50 and 52 provided on the outer face of the gear member and on the outer face of the hub member respectively permit a clear visual indication of the timing adjustment being made.

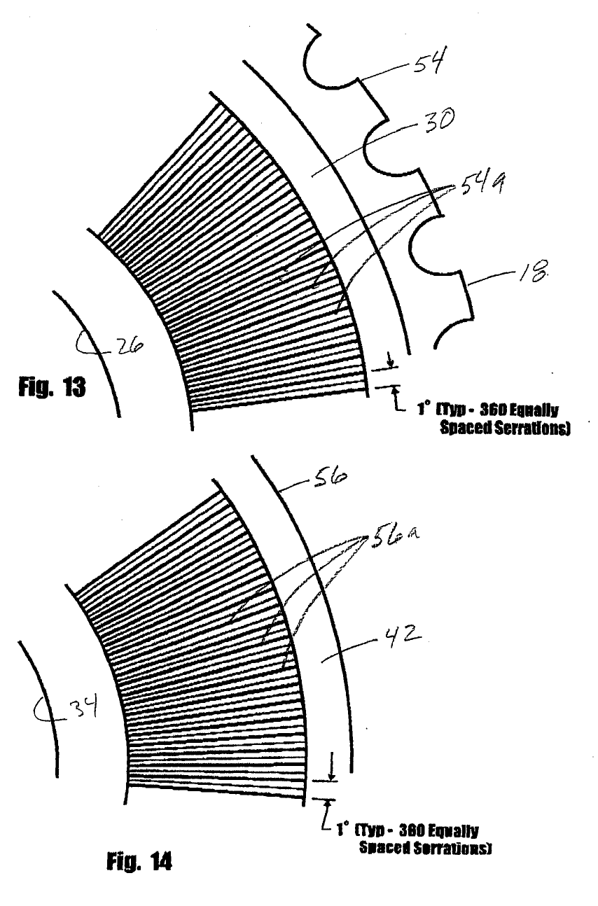

Turning now to FIGS. 13 and 14, fragmentary views of gear and hub components 54 and 56 respectively of an alternate form of the apparatus of the invention are shown. These components are identical in construction and operation to those previously described herein, save for the fact that the serrations 54a and 56a respectively that are formed thereon are spaced apart in one degree intervals rather than in two degree intervals. While in most instances involving camshaft adjustments of conventional engines, camshaft adjustments in two degree intervals is all that is required, camshaft adjustments in one degree intervals are useful for accomplishing timing adjustments in high-performance engines such as those found in Formula One and like automobiles. Accordingly, the apparatus of the invention illustrated in FIGS. 13 and 14, wherein 360 radially inwardly extending serrations are provided on each of the gear and hub components, finds application in providing precise timing adjustments in such high-performance engines.

Having now described the invention in detail in accordance with the requirements of the patent statutes, those skilled in this art will have no difficulty in making changes and modifications in the individual parts or their relative assembly in order to meet specific requirements or conditions. Such changes and modifications may be made without departing from the scope and spirit of the invention, as set forth in the following claims.

We claim:

1. An adjustable timing gear comprising:
(a) a gear member having a peripheral portion, a multiplicity of spaced-apart teeth formed on said peripheral portion and an inner mounting web connected to the said peripheral portion, said peripheral portion and said inner mounting web cooperating to define an internal chamber, said inner mounting web having a central opening and a plurality of circumferentially spaced-apart threaded bores, said inner mounting web further including an outer surface and an inner surface, said inner surface having an annular portion extending from said central opening to said peripheral portion, said annular portion being provided with a multiplicity of serrations, said serrations extending radially inwardly along a substantial portion of said annular portion of said inner surface of said mounting web;
(b) a hub member closely received within said internal chamber of said gear member, said hub member having a peripheral portion, a central opening and a plurality of circumferentially spaced apart elongated openings, said hub member having an outer surface and an inner surface, said inner surface having an annular portion extending between said central opening and said peripheral portion, said annular portion being provided with a multiplicity of serrations, said serrations extending radially inwardly along a substantial portion of said annular portion of said inner surface of said hub member; and
(c) connector means operably associated with said gear member for interconnecting said hub member with said gear member.

2. The timing gear as defined in claim 1 in which said connector means comprises a plurality of circumferentially spaced threaded connectors, each having a threaded shank receivable within a selected one of said circumferentially spaced apart threaded bores formed and said mounting web.

3. The timing gear as defined in claim 1 in which said annular portion of said inner surface of said mounting web is provided with 180 radially inwardly extending serrations, said serrations being approximately two degrees apart.

4. The timing gear as defined in claim 3 in which said annular portion of said inner surface of said hub member is provided with 180 radially inwardly extending serrations, said serrations being so constructed and arranged as to mesh with said serrations formed on said mounting web and being located approximately two degrees apart.

5. The timing gear as defined in claim 1 in which said annular portion of said inner surface of said mounting web is provided with 360 radially inwardly extending serrations, said serrations being approximately one degree apart.

6. The timing gear as defined in claim 3 in which said annular portion of said inner surface of said hub member is provided with 360 radially inwardly extending serrations, said serrations being so constructed and arranged as to mesh with said serrations formed on said mounting web and being located approximately one degree apart.

7. An adjustable timing gear comprising:
(a) a gear member having a peripheral portion, a multiplicity of spaced apart teeth formed on said peripheral portion and an inner mounting web connected to the said peripheral portion, said peripheral portion and said inner mounting web cooperating to define an internal chamber, said inner mounting web having:
(i) a central opening;
(ii) a plurality of circumferentially spaced apart threaded bores;
(iii) an outer surface; and
(iv) an inner surface having at least 180 equally spaced apart, radially inwardly extending serrations formed thereon, said serrations extending a substantial distance between the said peripheral portion of said gear member and said central opening of said gear member;
(b) a hub member closely received within said internal chamber of said gear member, said hub member having a peripheral portion, a central opening and a plurality of circumferentially spaced apart elongated openings, said hub member having an outer surface and an inner surface, said inner surface having at least 180 equally spaced, radially inwardly extending serrations formed thereon, said serrations extending a substantial distance between the said peripheral portion of said hub member and said central opening formed in said hub member and being so constructed and arranged as to mesh with said serrations formed on said mounting web when said hub member is interconnected with said gear member; and
(c) connector means operably associated with said gear member for interconnecting said hub member with said gear member.

8. The timing gear as defined in claim 7 in which said connector means comprises a plurality of circumferentially spaced threaded connectors, each having a threaded shank receivable within a selected one of said plurality of circumferentially spaced apart elongated openings formed in said hub member and within a selected one of said circumferentially spaced-apart threaded bores formed and said mounting web.

9. The timing gear as defined in claim 8 in which said mounting web is provided with three spaced-apart threaded bores and in which said hub member is provided with three spaced-apart elongated openings, said threaded bores being arranged to align with said spaced-apart elongated openings when said hub member is interconnected with said gear member.

10. The timing gear as defined in claim 9 in which said threaded bores formed in said mounting web are spaced approximately 120 degrees apart.

11. The timing gear as defined in claim 10 in which said spaced-apart elongated openings threaded bores formed in said hub member are spaced approximately 120 degrees apart.

12. An adjustable timing gear comprising:
(a) a gear member having a peripheral portion, a multiplicity of spaced-apart teeth formed on said peripheral portion and an inner mounting web connected to the said peripheral portion, said peripheral portion and said inner mounting web cooperating to define an internal chamber, said inner mounting web having:
(i) a central opening;
(ii) three circumferentially spaced-apart threaded bores;
(iii) an outer surface; and
(iv) an inner surface having 360 equally spaced apart, radially inwardly extending serrations formed thereon, said serrations extending a substantial distance between the said peripheral portion of said gear member and said central opening of said gear member;
(b) a hub member closely received within said internal chamber of said gear member, said hub member having a peripheral portion, a central opening and three circumferentially spaced apart elongated openings, said hub member having an outer surface and an inner surface, said inner surface having 360 equally spaced, radially inwardly extending serrations formed thereon, said serrations extending a substantial distance between the said peripheral portion of said hub member and said central opening formed in said hub member and being so constructed and arranged as to mesh with said serrations formed on said mounting web when said hub member is interconnected with said gear member; and
(c) connector means operably associated with said gear member for interconnecting said hub member with said gear member, said connector means comprising a plurality of circumferentially spaced threaded connectors, each having a threaded shank receivable within a selected one of said circumferentially spaced-apart elongated openings formed in said hub member and within a selected one of said circumferentially spaced-apart threaded bores formed and said mounting web.

13. The timing gear as defined in claim 12 in which said threaded bores formed in said mounting web are spaced approximately 120 degrees apart.

14. The timing gear as defined in claim 13 in which said spaced-apart elongated openings formed in said hub member are spaced approximately 120 degrees apart.

15. A method of making an adjustable timing gear which includes a gear member having a peripheral portion, a multiplicity of spaced apart teeth formed on the peripheral portion and an inner mounting web connected to the peripheral portion, the inner mounting web having an inner surface; and a hub member interconnectable with the gear member, the hub member having an inner surface, the method comprising the steps of:
(a) turning the inner face of the gear member at approximately one degree negative to form an inwardly angled surface;
(b) cutting at approximately one degree positive said inwardly angled surface of the gear member to form a multiplicity of circumferentially spaced apart teeth;
(c) turning the inner face of the hub member at approximately one degree negative to form an inwardly angled hub surface; and
(d) cutting at approximately one degree positive the inner face of the hub member to form a multiplicity of circumferentially spaced-apart teeth.

16. The method as defined in claim 15 in which 180 circumferentially spaced teeth are formed on said inwardly angled surface of the gear member and in which 180 circumferentially spaced teeth are formed on said inwardly angled hub surface of said hub member.

17. The method as defined in claim 15 in which 360 circumferentially spaced teeth are formed on said inwardly angled surface of the gear member and in which 360 circumferentially spaced teeth are formed on said inwardly angled hub surface of said hub member.
